(19) United States
(12) Patent Application Publication
(10) Pub. No.: US 2015/0210037 A1
(43) Pub. Date: Jul. 30, 2015

(54) ABSORBENT, CUSHIONED, IMPERMEABLE, REVERSIBLE, NON-SLIP, NON-CURLING LAMINATE LINER KIT WITH CUTTING GUIDE

(71) Applicant: Mark Todd, Jacksonville, FL (US)

(72) Inventor: Mark Todd, Jacksonville, FL (US)

(21) Appl. No.: 14/166,141

(22) Filed: Jan. 28, 2014

(51) Int. Cl. B32B 5/24; B32B 3/10; B26D 5/00; B32B 5/18

(52) U.S. Cl. CPC B32B 5/245; B32B 5/18; B32B 3/10; B26D 5/00

(57) ABSTRACT

A liner includes an abrasion layer comprised of a water impermeable film, a cushioning foam intermediate layer, and an absorbent layer comprised of an absorbent fabric. The abrasion layer may be a PVC film of approximately 1 mm to 0.1 mm in thickness. The cushioning foam intermediate layer may be comprised of a PVC, 1 mm to 4 mm in thickness. The absorbent layer may be comprised of felt and may be cure bonded to the second surface of the cushioning foam intermediate layer. A cutting guide tool with an alignment head and at least one blade guide runner is also provided. Each blade guide runner has a blade channel extending along the length of the blade guide runner and may display measurement indicia to facilitate precise cutting.

### FIELD OF THE INVENTION

This invention generally relates to shelf liners, and more particularly, to an absorbent, cushioned, impermeable, reversible, non-slip, non-curling laminate liner, such as a shelf liner or mat, with a liner cutting guide.

### BACKGROUND

Conventional shelf liners are produced using polymeric (e.g., vinyl) and/or paper sheets. The paper sheets are typically comprised of natural and/or synthetic fibers, particularly fibers derived from plant material such as wood pulp, cotton flax, and the like. Such shelf liners are generally decorated and coated with a resin material on a top side and coated with an adhesive on a bottom side. The benefits of using liners reside primarily in offering a decorative surface to the shelf while simultaneously providing a protective layer which will prevent damage, such as, for example, water damage to the shelf structure itself. While such conventional shelf liners are generally useful as a layer of protection for the underlying shelf, they have several shortcomings.

Conventional liners are generally offered in roll form and must be trimmed to proper size to fit the dimensions of a surface, such as a shelf. The trimming process entails using scissors or a knife to cut a piece to size. Often the process is imprecise and the cut edge is frayed and not straight, resulting in an unattractive piece. Once cut, the product is either adhered with an adhesive or with tacks to the shelf surface or it is simply positioned on top of the shelf, otherwise unsecured.

Among the problems of conventional liners that do not include an adhesive backing is that the liner shifts and lifts from the surface while items stored thereon are positioned or removed. Liners that include a pressure sensitive adhesive are difficult to position correctly on the shelf and are also difficult to remove. After being left in place for an extended period of time, adhesive liners become difficult to remove cleanly. Removable adhesive—backed liners often lose their removable characteristics after repeated applications and tend to gather dirt and lint on their adhesive surfaces.

Various liners have been made utilizing a foamed plastic coating on an open scrim. The scrim coated with the foamed plastic is porous and has openings, which pass from one surface to the other. In some embodiments, a smooth film of a non-foamed plastic may then be laminated over the surface of the scrim coated with the foamed plastic. The foam plastic coated scrim acts as a non-slip cushioning base for the liner, while the top sheet material provides an impermeable surface. However, these products are non-absorbent. Additionally, the top sheets are not flat and smooth, as they adhere to a bumpy foam-coated scrim cushioning layer. Moreover, over time, these products have a tendency to curl rather than lay flat. Such products are described in patents including are disclosed in U.S. Pat. No. 5,707,903, U.S. Pat. No. 5,863,845, U.S. Pat. No. 5,874,371 and U.S. Pat. No. 6,130,174, for example.

One drawback of some conventional liners is water incompatibility. For example, conventional paper shelf liners have problems with water absorption of the fibers. Absorbed water results in deformation of the paper and separation of the liner from the adhesive.

Another drawback of some conventional liners is lack of durability and stability. For example, paper shelf liners also have a tendency to tear, leaving portions of the shelf liner attached to the shelves when the shelf liner is removed or repositioned. Conventional shelf liners also have a tendency to curl, leaving portions of the shelf exposed.

Another drawback of some conventional liners is an inability to absorb water. Polymeric liners do not absorb water. Instead, drippings accumulate and run off to the underlying shelf, resulting in water damage.

Another drawback of some conventional liners is lack of cushioning. Many conventional liners provide an un-cushioned surface layer that renders dropped breakable items susceptible to breakage. Such un-cushioned surfaces also do not absorb the energy of impact of a dropped item, thereby exposing the underlying surface to impact damage.

Yet another drawback of some conventional liners is lack of sound suppression. Many conventional liners provide a thin surface layer that does not provide a buffer or attenuate sounds as items such as pots, pans and tools are placed thereon. Such un-cushioned surfaces do not absorb the energy of impact of an item placed thereon or suppress the percussive sounds generated therefrom.

Still another drawback of conventional liners is that they have limited versatility. In most cases, they are not reversible. Instead they are designed to be used with one side facing upwardly and the other side facing downwardly. Those that are reversible typically provide two sides that are identical, with neither side providing any unique property over the other side. This limits the versatility of conventional liners.

None of the known prior art liners, taken either singularly or in combination, describes the instant invention as claimed. What is needed is an aesthetically pleasing absorbent, cushioned, impermeable, non-slip, non-curling, flat laying liner, along with a convenient means for neatly cutting such a liner, which solves the problems described above and can be neatly trimmed to accommodate a particular surface. The invention is directed to overcoming one or more of the problems and solving one or more of the needs as set forth above.

### SUMMARY OF THE INVENTION

To solve one or more of the problems set forth above, in an exemplary implementation of the invention, an absorbent, cushioned, impermeable, reversible, non-slip, non-curling, flat laying liner, along with a convenient means for neatly cutting such a liner, are provided. An exemplary liner according to principles of the invention is adapted for use with a countertop, drawer, cabinet or shelf to protect a surface on the countertop or shelf, or in the drawer or cabinet. The exemplary liner includes an abrasion layer comprised of a water impermeable film. The abrasion layer has a first surface and a second surface. The exemplary liner also includes a cushioning foam intermediate layer having a first surface and a second surface. The first surface of the cushioning foam intermediate layer is attached to the second surface of the abrasion layer. The exemplary liner also includes an absorbent layer comprised of an absorbent fabric. The absorbent layer has a first surface and a second surface. The first surface of the absorbent layer is attached to the second surface of the cushioning foam intermediate layer. The abrasion layer may be a PVC film of approximately 1 mm to 0.1 mm in thickness. The cushioning foam intermediate layer may be comprised of a PVC, 1 mm to 4 mm in thickness. The absorbent layer may be comprised of felt and may be cure bonded to the second surface of the cushioning foam intermediate layer.

Optionally, the liner may include a cutting guide layer. The cutting guide layer may be a thin removably-adhered, disposable film with a visible grid (e.g., perpendicular lines gauged to conventional liner sizes) to guide cutting.

As another option, the liner may include removable visible cutting guide indicia on the first surface of the abrasion layer. The indicia may be visible markings of chalk, graphite, charcoal, clay, erasable ink, water soluble ink, or water soluble paint.

In another exemplary embodiment, a liner kit is provided for use in creating a liner from a roll of liner material. The liner material includes an abrasion layer comprised of a water impermeable film. The abrasion layer has a first surface and a second surface. The exemplary liner also includes a cushioning foam intermediate layer having a first surface and a second surface. The first surface of the cushioning foam intermediate layer is attached to the second surface of the abrasion layer. The exemplary liner also includes an absorbent layer comprised of an absorbent fabric. The absorbent layer has a first surface and a second surface. The first surface of the absorbent layer is attached to the second surface of the cushioning foam intermediate layer. The abrasion layer may be a PVC film of approximately 1 mm to 0.1 mm in thickness. The cushioning foam intermediate layer may be comprised of a PVC, 1 mm to 4 mm in thickness. The absorbent layer may be comprised of felt and may be cure bonded to the second surface of the cushioning foam intermediate layer.

The kit also includes a cutting guide tool with a head and at least one blade guide runner. The head includes a planar base and at least one alignment tab projecting from the base and alignment tab projections adapted to engage an edge of the liner material. Each blade guide runner has a blade channel extending along the length of the blade guide runner and an attachment for connection to the head. The alignment tabs maintain a blade guide runner perpendicular to an engaged edge of the liner material when the blade guide runner is connected to the head. The blade channels may have a v-shaped notch cross-section. The kit may include a plurality of blade guide runners, each having an attachment for connection to the head and another blade guide runner. Furthermore, the blade guide runners may display measurement indicia. The kit may also include a cutting blade. The cutting guide tool may be stored within the roll of liner material.

An exemplary method of creating a liner cut to size from a roll of liner material using a cutting tool guide, according to principles of the invention, includes steps of providing a roll of liner material. The liner material includes an abrasion layer comprised of a water impermeable film. The abrasion layer has a first surface and a second surface. The exemplary liner also includes a cushioning foam intermediate layer having a first surface and a second surface. The first surface of the cushioning foam intermediate layer is attached to the second surface of the abrasion layer. The exemplary liner also includes an absorbent layer comprised of an absorbent fabric. The absorbent layer has a first surface and a second surface. The first surface of the absorbent layer is attached to the second surface of the cushioning foam intermediate layer. The abrasion layer may be a PVC film of approximately 1 mm to 0.1 mm in thickness. The cushioning foam intermediate layer may be comprised of a PVC, 1 mm to 4 mm in thickness. The absorbent layer may be comprised of felt and may be cure bonded to the second surface of the cushioning foam intermediate layer.

An exemplary method according to principles of the invention entails unrolling a determined length of the liner material from the roll of liner material. Then the cutting guide tool is positioned for a cut at the determined length of unrolled liner material. Then a cut is made by moving the blade from the head along the blade channel.

If the cutting tool guide is provided unassembled, then the method may include a step of assembling the cutting tool guide by attaching the head to a blade guide runner. If the cutting tool guide is provided within the roll of liner material, then the method includes removing the unassembled cutting tool guide from within the roll of liner material. Additional blade guide runners may be attached in seriatim to as needed.

### BRIEF DESCRIPTION OF THE DRAWINGS

The foregoing and other aspects, objects, features and advantages of the invention will become better understood with reference to the following description, appended claims, and accompanying drawings, where:

FIG. 1A shows a sectional view of an exemplary liner according to principles of the invention; and

FIG. 1B shows a sectional view of an exemplary liner with an optional removable cutting guide layer according to principles of the invention; and

FIG. 2 shows a roll of an exemplary liner with an optional removable cutting guide layer according to principles of the invention; and

FIG. 3 shows a modular cutting guide according to principles of the invention; and

FIG. 4 conceptually illustrates steps 1 and 2 of an exemplary process of preparing a liner for installation according to principles of the invention; and

FIG. 5 conceptually illustrates steps 3 and 4 of an exemplary process of preparing a liner for installation according to principles of the invention; and

FIG. 6 conceptually illustrates steps 5 and 6 of an exemplary process of preparing a liner for installation according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, ornamental aspects or proportions shown in the figures.

### DETAILED DESCRIPTION

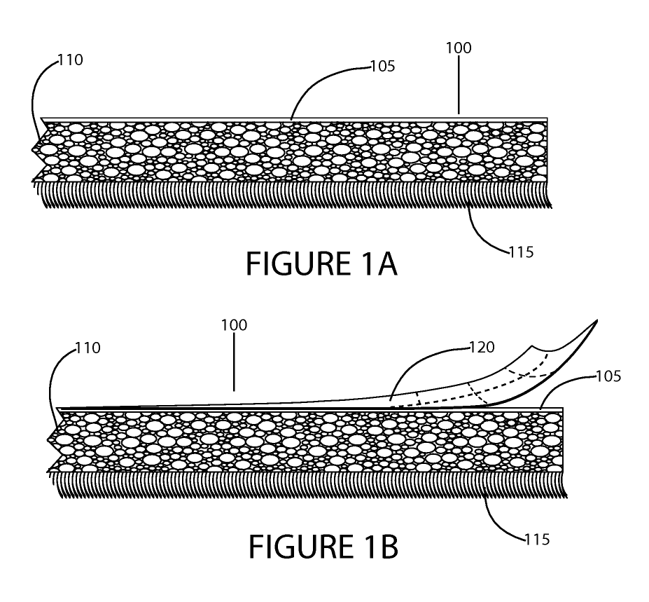

Referring to the Figures, in which like parts are indicated with the same reference numerals, various views of an exemplary liner and process for preparing the liner for installation according to principles of the invention are shown. Referring to FIG. 1A a sectional view of an exemplary liner 100 according to principles of the invention is shown. The abrasion layer 105 of the exemplary liner 100 is comprised of an water impermeable film, such as a polyvinylchloride (PVC) film. The PVC film may be formed using a fabric production web process such as calendering or cast coating. The abrasion layer 105 is relatively thin, from approximately 1 mm to 0.1 mm in thickness, and preferably 0.25 mm in thickness. During calendaring, rolls of the materials are passed between several pairs of heated rollers, applying heat and pressure. In cast coating, the abrasion layer 105 is formed by pouring (or casting) a liquid vinyl mixture (or organosol) onto a moving web known as the casting sheet. The material is then processed through a series of ovens allowing for the evaporation of solvents. When the solvents have evaporated, a solid film comprising the abrasion layer 105 is left behind. Of the two processes, cast coating is preferred because of its ability to produce a higher quality abrasion layer 105 and a final liner product 100 less prone to shrinkage. Those skilled in the art will appreciate that other materials and other film forming techniques may be utilized to produce a water-impermeable abrasion layer 105 in accordance with the principles of the invention.

In an exemplary embodiment, the intermediate layer is a cushioning foam layer 110, also referred to herein as a sponge layer. The foam is a relatively lightweight material in cellular form, made by introducing gas bubbles during manufacture. The intermediate layer 110 is relatively thick, from approximately 1 mm to 4 mm in thickness, and preferably 2 mm in thickness. In a particular preferred embodiment, the intermediate layer is comprised of a PVC mixture with an added blowing agent such as nitrogen. The mixture may be poured onto the previously created abrasion layer 105 and processed with heat to cause a catalytic conversion. Gas is released causing the material to rise and form bubbles, resulting in a sponge-like foam material comprising the intermediate layer 110. Those skilled in the art will appreciate that other materials and other closed and open-cell foam forming techniques may be utilized to produce a cushioning intermediate layer bonded to the abrasion layer 105 in accordance with the principles of the invention. By way of example and not limitation, Neoprene®, DuPont Performance Elastomers' trade name for synthetic rubbers based on polychloroprene (a polymer form of Chloroprene) may serve as the intermediate layer 110.

Advantageously, the intermediate layer 110 provides cushioning and suppresses sounds. The cushioning absorbs the energy of impact of items placed thereon, reducing the risk of breakage and protecting the underlying surface from impact damage. Concomitantly, the cushioning provides a buffer that suppresses percussive sounds as items such as pots, pans and tools are placed thereon.

The absorbent layer 115, also referred to as a felt layer, is comprised of a soft, non-abrasive, absorbent fabric, such as a felt or a felt-like fabric. As used herein, felt-like fabric refers to any a non-woven cloth that is produced from natural and/or synthetic fibers. The absorbent layer 115 has an intermediate thickness, from approximately 0.5 mm to 3 mm in thickness, and preferably 1 mm in thickness. The felt may be comprised of natural and/or synthetic fibers. To facilitate bonding, the felt layer 115 may be applied to the intermediate layer 110 while the intermediate layer 110 is hot and in a high tack state. Upon curing, the intermediate layer 110 intimately engages fibers of the felt layer 115, thereby creating a strong bond between the intermediate 110 and absorbent 115 layers. Such bonding is referred to as cure bonded.

Advantageously, the exposed felt helps keep the covered surface dry. More specifically, the thin felt layer 115 absorbs and “wicks away” liquid, dispersing the absorbed liquid across the thin felt layer 115, where it quickly evaporates. Because of surface tension, small droplets tend to bead on top of the upwardly facing felt surface, where they also evaporate quickly.

In an exemplary embodiment, the absorbent layer 115, intermediate layer 110 and/or the abrasion layer 105 may be comprised of a material that includes an effective amount of one or more hygienic additives, such as anti-fungal, anti-microbial, anti-bacterial agents. By way of example and not limitation, felt fibers comprising the absorbent layer 115 or material comprising the abrasion layer 105 may be coated with or include a material containing an effective amount of an agent such as chlorophene, dichloroxylenol, hexachloraphane, diacetylaminoazotoluene, triclocarban, triclosan, silver ion releasing additives, and/or any other compatible agent now known or hereafter developed and suitable for providing anti-microbial, anti-fungal and/or anti-bacterial benefits.

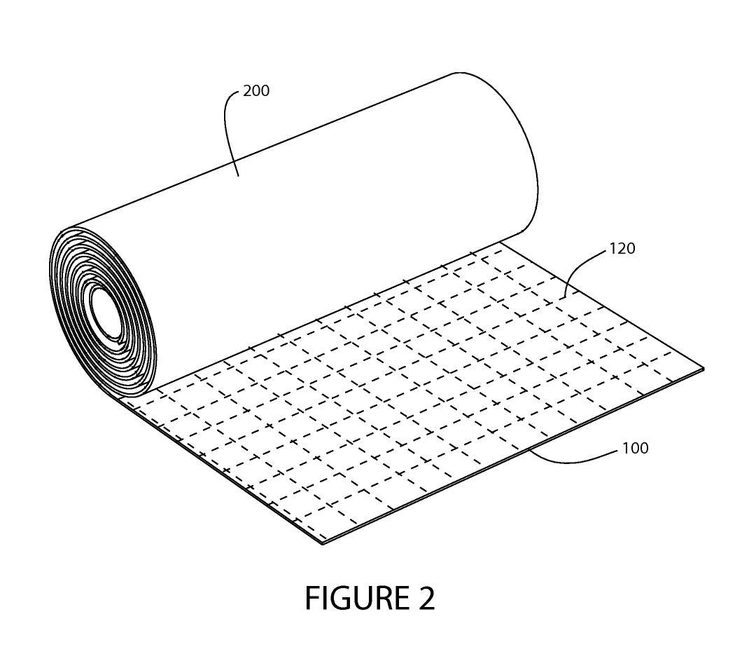

The liner 100 can be difficult to measure, mark, and cut (for the average user, using commonly available blades or scissors) with any great degree of accuracy. To address this problem, a cutting guide layer 120, such as a thin adhered film with a grid or line pattern (gauged to common applications, i.e., cabinet, drawer and shelf sizes) may be provided, as shown in FIGS. 1B and 2. This film may be clear PVC and manufactured in a web calendaring or cast coating process, similar to the process described above for the liner material itself. Preferably, the cutting guide layer 120 can be easily removed after cutting, without leaving any residue. The cutting guide layer 120 displays a grid, i.e., a pattern of regularly spaced horizontal and vertical lines. The grid provides a cutting guide to facilitate making straight and properly sized cuts. The grid may be configured to provide horizontal and vertical lines gauged to conventional shelf, drawer and cabinet sizes. The cutting guide layer 120 preferably features a prefabricated low tack adhesion to bond to the abrasion layer 105. The cutting guide layer 120 may be added last in the web process. After the liner 100 is cut to size, the cutting guide layer 120 may be peeled off the liner 100, without leaving any residue, and then discarded.

As an alternative form of the cutting guide, removable (e.g., erasable) visible cutting guide indicia may be provided on the first surface of the abrasion layer. By way of example and not limitation, the abrasion layer 105 of the liner 100 may be marked during manufacturing with a semi-permanent grid (cut lines) that could be easily wiped off by a consumer after cutting. This marking material could be a chalk-like, graphite (such as erasable pencil markings), charcoal, clay, erasable ink or water soluble ink or paint, or some other temporary easily-removed material.

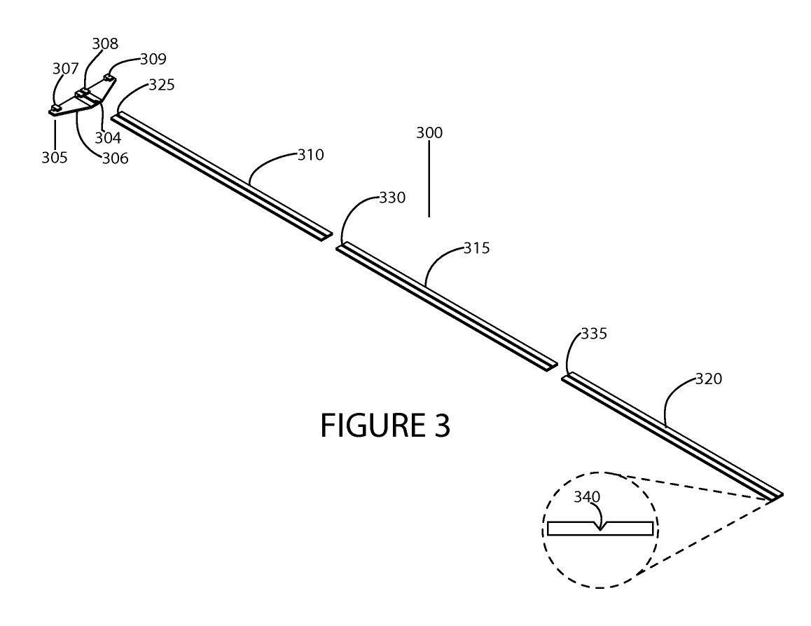

Due to the thickness of the liner 100, making a good, clean and straight cut can be challenging. In many applications, such as kitchen cabinetry and display, the edges are visible. The material is not easily cut using standard household scissors. In fact, using scissors of any kind is slow and leaves unattractive, serrated, frayed edges. While a blade (e.g., a single edge razor, X-Acto® knife, box cutter, and the like) can produce a much cleaner cut, executing straight “free hand” cuts is extremely difficult. Additionally, preventing damage to underlying work surfaces (such as countertops, floors, etc.) is a challenge. To solve these problems an embodiment of the invention includes a cutting guide tool 300, as shown in FIG. 3.

The cutting guide layer 120 and the cutting guide tool 300 individually and collectively constitute “a cutting guide” as that term is used herein. Thus, an exemplary liner having a cutting guide according to principles of the invention may include both a cutting guide layer 120 and a cutting guide tool 300, or a cutting guide layer 120 without the cutting guide tool 300, or a cutting guide tool 300 without the cutting guide layer 120. All such embodiments are intended to come within the scope of the invention.

The cutting guide tool 300 facilitates quick and accurate cuts while conveniently eliminating the chance of work surface damage. With the cutting guide tool 300, a user can make clean cuts using a blade on any available work surface without the risk of damage. As shown in FIG. 3, an exemplary cutting guide tool 300 includes a plurality of pieces, namely, a plurality of blade guide runners 310-320 and a head 305. Each of the runners 310-320 and head 305 feature a blade channel 325-335 having a v-shaped notch 340 cross-section and extending along the length of each runner 310-320 and part of the length of the head 305. The blade channel 325-335 guides a blade during a cutting stroke.

The head 305 includes a planar base 306 and a plurality of alignment tabs 307-309 adapted projecting therefrom and adapted to engage an edge of a liner 100 and maintain the head 305 and attached runners 310-320 perpendicular to the engaged edge of the liner 100. Thus, the head 305 aligns the assembled cutting guide 300 perpendicular to the liner 100 edge. The head also includes a starter channel 304 to commence making a cut in alignment with the blade channels 325-335 of the runners.

Releasable and/or permanent attachments may be used to assemble the cutting guide tool 300. The head 305 is adapted for permanent or releasable attachment to a runner 310-320. In a preferred embodiment, the head 305 is connected by snap fit connection or some other means of releasable or permanent attachment. Likewise, each runner 310-320 may be connected by snap fit connection or some other means of releasable or permanent attachment to achieve a desired overall length. In each case, the connections may include male/female connectivity.

To facilitate measuring, the runners 310-320 may include measurement indicia (e.g., markings printed, bossed or embossed thereon) adapted to show the distance from the edge. If measurement lines are provided on the runners 310-320, then each runner end may have a unique key/reference shape or an indicator to dictate proper connection order.

The cutting guide tool 300 may be comprised of various materials, such as metal and/or plastic. The cutting guide tool 300 is preferably sufficiently sturdy and strong such that it does not structurally fail and resists substantial deformation from stresses and conditions encountered during use. By way of example and not limitation, aluminum, steel, alloys thereof or other metallic materials conventionally used for manufacturing tools may be utilized. Such materials may be plated, coated or otherwise finished to provide a decorative, aesthetic pleasing and/or corrosion resistant finish for the apparatus.

In another exemplary implementation, the cutting guide tool 300 is comprised of a rigid plastic or polymeric material, such as a glass filled nylon, or polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates or polyesters. While many other materials may be used alone or in combination with the aforementioned materials and/or other materials, without departing from the scope of the present invention, preferably the material is relatively inexpensive, easy to use in manufacturing operations and results in an aesthetically acceptable, durable product. The material may further include additives to provide desired properties such as desired colors, structural characteristics and glow-in-the dark properties.

The cutting guide tool 300 may be produced using any suitable manufacturing techniques known in the art for the chosen material, such as (for example) milling, casting, stamping and machining in the case of a metal cutting guide tool 300, and injection, compression, structural foam, blow, or transfer molding; polyurethane foam processing techniques; vacuum forming; and casting, in the case of a plastic cutting guide tool 300. Preferably, the manufacturing technique is suitable for mass production at relatively low cost per unit, and results in an aesthetically acceptable product with the requisite structural properties and a consistent acceptable quality.

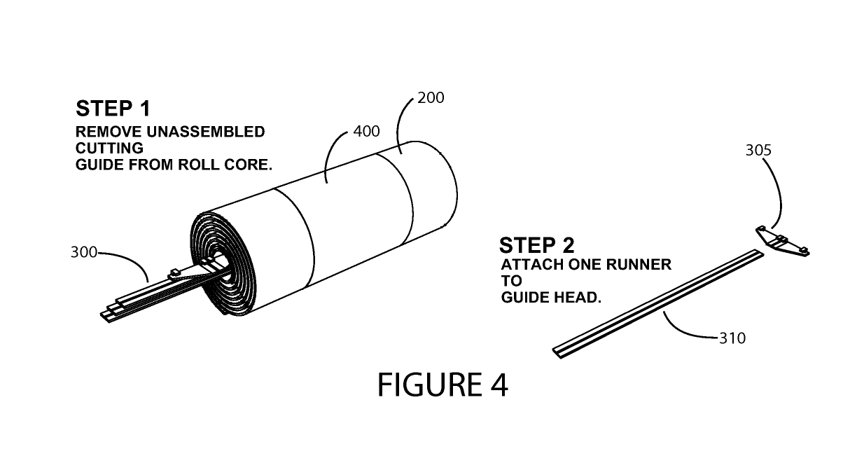

In a preferred embodiment, the liner 100 and cutting guide tool 300 are provided together as a kit. The liner 100 may be provided in a roll 200 as shown in FIG. 2. The cutting guide tool 300 may be provided unassembled in the hollow tubular center of a roll 200. Alternatively, the cutting guide tool 300 may be provided with a plurality of rolls, or as a separate accessory. Thus, a customer may purchase five rolls of liner to outfit a kitchen, with one cutting guide tool. A blade may also be included in the kit. Each roll may be contained by a sleeve 400, as shown in FIG. 4, which may be cut or slid off to facilitate removal. The entire kit may be packaged in a bag, box and/or other container suitable for distribution, display and marketing.

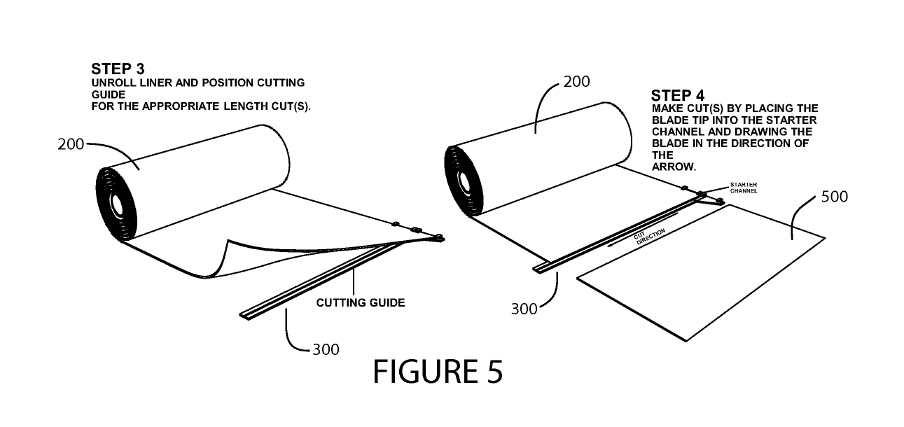

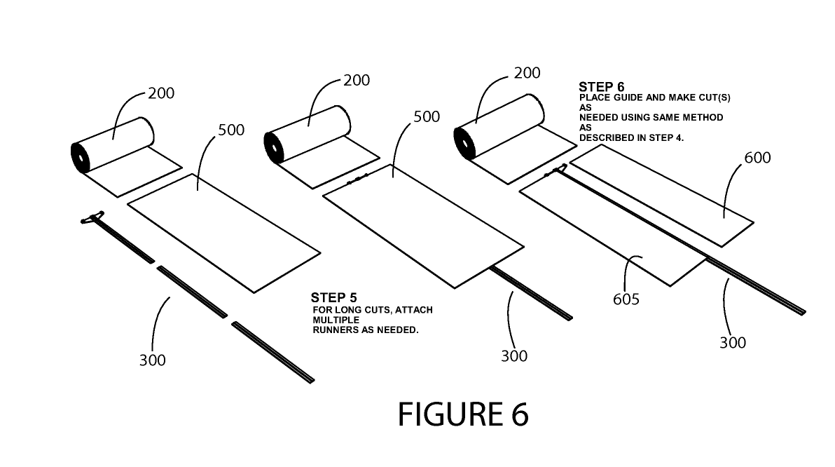

A method of using such a kit to create a liner cut to size from a roll of liner material using a cutting tool guide is also provided herein. Referring to FIG. 4, the method entails removing an unassembled cutting guide tool 300 from the roll 200 core, as in step 1. Next, the cutting guide tool 300 is assembled. A runner 310 is attached to the guide head 305, as in step 2. Next, referring to FIG. 5, the liner 200 is unrolled and the assembled cutting guide tool 300 is positioned for appropriate length cuts, as in step 3. Then, a first cut is made by placing a blade tip into the starter channel 304 and drawing the blade in the cut direction towards the free end of the attached runner(s), as in step 4. After the first cut, the removed section 500 may be cut again to achieve desired dimensions. For example, referring to FIG. 6, a cut section may be cut along an axis perpendicular to the axis of the first cut. For a long cut, several runners 310-320 may be connected as needed, as in step 5. Then, the cutting guide tool 300 is positioned and the cut is made by placing a blade tip into the starter channel 304 and drawing the blade in the cut direction towards the free end of the attached runner(s), as in step 6. The result is two cut liner sections 600, 605. The cutting steps may be repeated to create each new section and to trim a section down to a determined size.

Advantageously, a liner according to principles of the invention is highly adaptable and versatile. Not only can the liner be neatly trimmed using the cutting guide as described above, but the liner is reversible, meaning that either side may be used as a top surface—i.e., the liner may be used with the absorbent layer up or the abrasion layer up. For example, the soft “felt” layer is well suited for shelf display of fine china, stemware etc. The soft “felt” layer is equally well suited for display in a commercial environment, such as gallery display cases containing fine art, artifacts, or jewelry, for example. Conversely, the abrasion layer is well suited for heavy duty drawer applications where items such as tools, pots and pans may be stored. Indeed, the liner may be oriented with the abrasion layer facing upwardly in any application where easy, periodic cleaning of the surface may be required. The adaptability and versatility of a liner according to principles of the invention affords a consumer freedom to purchase the product without careful advance calculation (e.g., measuring) of the areas for each application, and without committing to solely a soft felt layer or solely an abrasion layer as a top surface. Some applications may utilize a soft felt top layer, while others may utilize an impermeable protective abrasion top layer, all from the same product. Furthermore, even after the liner is installed, a particular application may be changed, any time in the future, by simply flipping the liner over.

Although the invention has been described with reference to a specific embodiment, the foregoing description is not intended to be construed in a limiting sense. Various modifications to the disclosed embodiment as well as alternative applications of the invention will be suggested to persons skilled in the art by the foregoing specification and illustrations. It is therefore contemplated that the appended claims will cover any such modifications, applications or embodiments as fall within the true scope of the invention.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A reversible liner adapted for use with a countertop, drawer, cabinet or shelf to protect a surface on said countertop or shelf, or in said drawer or cabinet, said liner comprising
an abrasion layer comprised of a water impermeable film, said abrasion layer having a first surface and a second surface,
a cushioning foam intermediate layer, said cushioning foam intermediate layer having a first surface and a second surface, said first surface of the cushioning foam intermediate layer being attached to said second surface of said abrasion layer, and
an absorbent layer comprised of an absorbent fabric, said absorbent layer having a first surface and a second surface, said first surface of the absorbent layer being attached to said second surface of said cushioning foam intermediate layer; and
a cutting guide layer comprising a thin removably-adhered film with a visible grid to guide cutting, said thin removably-adhered film being applied to at least one of the abrasion layer and the absorbent layer;
wherein said liner is adapted for use with the abrasion layer facing upwardly and with the absorbent layer facing upwardly, as selected by a user.

2. A liner according to claim 1, wherein the abrasion layer is a PVC film from approximately 1 mm to 0.1 mm in thickness.

3. A liner according to claim 1 wherein the cushioning foam intermediate layer is comprised of a PVC, 1 mm to 4 mm in thickness.

4. A liner according to claim 1, wherein the absorbent layer is comprised of a material from the group consisting of felt and a non-woven cloth.

5. A liner according to claim 1, wherein the absorbent layer is comprised of felt and the first surface of the absorbent layer is cure bonded to the second surface of the cushioning foam intermediate layer.

6. (canceled)

7. A liner according to claim 1, said grid including perpendicular lines gauged to conventional liner sizes.

8. (canceled)

9. (canceled)

10. A liner kit for use in creating a liner from a roll of liner material, said liner being adapted for use in protecting a countertop, drawer, cabinet or shelf, said liner kit comprising
at least one roll of liner material, each roll of liner material comprising
an abrasion layer comprised of a water impermeable film, said abrasion layer having a first surface and a second surface,
a cushioning foam intermediate layer, said cushioning foam intermediate layer having a first surface and a second surface, said first surface of the cushioning foam intermediate layer being attached to said second surface of said abrasion layer, and
an absorbent layer comprised of an absorbent fabric, said absorbent layer having a first surface and a second surface, said first surface of the absorbent layer being attached to said second surface of said cushioning foam intermediate layer; and
a cutting guide tool, said cutting guide tool comprising a head and at least one blade guide runner,
said head including a planar base and at least one alignment tabs projecting from the base and adapted to engage an edge of said liner material, and
each of the at least one blade guide runner having a blade channel extending along the length of the blade guide runner, each of the at least one blade guide runner having an attachment for connection to said head, and said alignment tabs being adapted to maintain a blade guide runner perpendicular to an engaged edge of said liner material when said blade guide runner is connected to said head.

11. A liner kit according to claim 10, wherein the blade channel has a v-shaped notch cross-section.

12. A liner kit according to claim 10, wherein the head includes blade channel and each blade channel has a v-shaped notch cross-section.

13. A liner kit according to claim 10, wherein the at least one blade guide runner includes a plurality of blade guide runners, each of said plurality of blade guide runners having an attachment for connection to said head and another blade guide runner.

14. A liner kit according to claim 10, wherein the at least one blade guide runner includes measurement indicia displayed thereon.

15. A liner kit according to claim 10, further comprising a cutting blade.

16. A liner kit according to claim 10, wherein the cutting guide tool is stored within said roll of liner material.

17. A method of creating a liner cut to size from a roll of liner material using a cutting tool guide, said method comprising steps of
providing a roll of liner material, said liner material comprising
an abrasion layer comprised of a water impermeable film, said abrasion layer having a first surface and a second surface,
a cushioning foam intermediate layer, said cushioning foam intermediate layer having a first surface and a second surface, said first surface of the cushioning foam intermediate layer being attached to said second surface of said abrasion layer, and
an absorbent layer comprised of an absorbent fabric, said absorbent layer having a first surface and a second surface, said first surface of the absorbent layer being attached to said second surface of said cushioning foam intermediate layer; and
providing a cutting guide tool, said cutting guide tool comprising a head and at least one blade guide runner,
said head including a planar base and at least one alignment tabs projecting from the base and adapted to engage an edge of said liner material, and
each of the at least one blade guide runner having a blade channel extending along the length of the blade guide runner, each of the at least one blade guide runner having an attachment for connection to said head, and said alignment tabs being adapted to maintain a blade guide runner perpendicular to an engaged edge of said liner material when said blade guide runner is connected to said head; and
providing a cutting blade; and
unrolling a determined length of the liner material from the roll of liner material; and
positioning the cutting guide tool for a cut at the determined length of unrolled liner material; and
making the cut by moving the blade from the head along the blade channel.

18. The method of creating a liner cut to size from a roll of liner material using a cutting tool guide according to claim 17, wherein said cutting tool guide is provided unassembled, and said method further comprising a step of assembling said cutting tool guide by attaching the head to one of the at least one blade guide runner.

19. The method of creating a liner cut to size from a roll of liner material using a cutting tool guide according to claim 17, wherein said cutting tool guide is provided unassembled and stored within said roll of liner material, and said method further comprising steps of
removing the unassembled cutting tool guide from within said roll of liner material; and
assembling said cutting tool guide by attaching the head to one of the at least one blade guide runner.

20. The method of creating a liner cut to size from a roll of liner material using a cutting tool guide according to claim 17, wherein said cutting tool guide is provided unassembled and stored within said roll of liner material, the at least one blade guide runner includes a plurality of blade guide runners, each of said plurality of blade guide runners having an attachment for connection to said head and another blade guide runner, and said method further comprising steps of
removing the unassembled cutting tool guide from within said roll of liner material; and
assembling said cutting tool guide by attaching the head to one of the at least one blade guide runner, and attaching said blade guide runner attached to the head to another blade guide runner.
